(19) United States
(12) Patent Application Publication
(10) Pub. No.: US 2004/0033336 A1
(43) Pub. Date: Feb. 19, 2004

(54) Hook-and-loop fastener produced from a shape memory plastic material

(76) Inventor: Axel Schulte, Holzgerlingen (DE)

Correspondence Address: Mark S Bicks, Roylance Abrams Berdo & Goodman, Suite 600, 1300 19th Street NW, Washington, DC, 20036, US

(21) Appl. No.: 10/433,948

(22) PCT Filed: Dec. 5, 2001
(86) PCT No.: PCT/EP01/14232

(30) Foreign Application Priority Data
Dec. 8, 2000 (DE) 100 61 952.5

(51) Int. Cl. B32B 3/06

(52) U.S. Cl. 428/100; 428/99

(57) ABSTRACT

The invention relates to a hook-and-loop fastener that comprises a support part (10) that is provided on at least one of its sides with hook-and-loop elements (12) of a predetermined hook shape and/or orientation. At least the hook-and-loop elements (12) are produced from a shape memory plastic material, and every hook-and-loop element (12), when undergoing different energy conditions, especially different temperatures, assumes a hook shape and/or orientation that differs from the initially predetermined hook shape and/or orientation, thereby providing a hook-and-loop fastener that, once produced, by supplying energy, can be geometrically modified in such a manner that the hook-and-loop fastener has a greater versatility.

The invention relates to a hook-and-loop fastener consisting of a support component which is provided on at least one of its sides with hook-and-loop fastening elements of a predetermined hook shape and/or orientation.

DE 198 28 856 C1 discloses a process for production of a hook-and-loop fastener and accordingly a conventional hook-and-loop fastener having a plurality of fastening elements integral with a backing component in the form of stems with thickened areas on the end, a thermoplastic in the plastic or liquid state being delivered to the gap between a pressure roller and a section roller and these rollers being driven in such a way that the support component is formed in the gap and advanced in a transport direction in which a sieve having through openings on the section roller is used as shaping element and in which the fastening elements are formed in that the thermoplastic sets at least to some extent in the openings of the sieve. In order to ensure good processing of the plastic material, provision is additionally made such that at least the section roller is tempered. Stability of the shape and the appearance of the fastener component is predetermined by the setting of the plastic material and neither the appearance of the interlocking mold nor the orientation of the fastening elements changes after the production process described has been carried out.

EP 0 374 961 B1 discloses a preform with shape memory capability in which a formed shape is frozen which is formed by shaping of a polymer resin with shape memory capability to a desired shape at a temperature above Ta, subsequent reshaping to a shape different from the shape formed at a temperature no higher than Ta, and chilling of the reshaped product to a temperature no higher than Tb, where the polymer resin with shape memory capability consists essentially of a block copolymer with a molecular weight mean in the range of 10,000 to 1,000,000 and with a block structure of the linear type or block structure of the grafted type. The block copolymer has a polymer block A which is cross-linked to a polymer block B, and the polymer resin employed possesses a property such that the relationship of the glass transition temperature Ta of the phase containing the polymer block A to the crystal melting point Tb of the phase containing the polymer block B is expressed by the following formula:

25° C. ≦Tb<Ta≦150° C.

The disclosed preform may be produced by a customary shaping process, such as one in the form of an extrusion molding process, and the configuration changes as soon as the corresponding glass extrusion temperature is exceeded. A new preform thus emerges with configurations different from those of the previous preform, it being possible to produce the original state again after the temperature falls below the glass transition temperature for the plastic material. The shape modification process is accordingly kept reversible; the newly produced shape of the hook-and-loop fastener does not change as long as a temperature above the glass transition temperature is maintained. The plastic material with shape memory capability employed accordingly undergoes change from an essentially amorphous structure to a directional crystalline partial structure with new configuration. In addition, only a simple, single modification of the geometric shape dimensions is possible with this preform as disclosed.

PCT/WO 99/45528 discloses a polymer-based plastic material with shape memory capability with which more than two geometric shape modifications are possible for a preform. For this purpose the polymer composition has a solid component with a glass transition temperature ranging from −40° C. to 270° C.; in addition to this solid component, at least two other soft components are cross-linked to each other. The soft components are provided with a glass transition temperature which is at least 10° C. below that of the preceding soft component; a soft component with the highest glass transition temperature has a temperature which is at least 10° C. lower than the glass transition temperature of the solid composite material. With the multiple structure of solid and soft components in question several geometric modifications reversible in chronological sequence may be obtained, as a function of the number of soft components.

PCT/WO 00/62637 discloses a detachable fastener of separable velcro-type elements having interlocking elements on the surface to be connected, elements which are interlocked with each other and hold the velcro-type elements together when the latter are brought together; the interlocking elements of plastic have a shape-memory alloy which, like bimetals and as a function of the temperature, cyclically and reversibly pass through individual shape states. The disclosed velcro-type elements consist of a surface formation of woven polyamide fiber into which a bimetal wire, such as one of a nickel-titanium alloy, has been woven in such a way that first eyelets are obtained which in a subsequent process are cut off on one side so that the hookshaped interlocking elements are formed. The alloy wire in question undergoes in the transition between martensitic and austenitic phases, as a function of the temperature, a change in shape which is used for opening the interlocking elements and which is rendered reversible as a function of the temperature and results in closing of the interlocking elements again. The fastener in question is expensive to produce and correspondingly heavy in view of the metal materials employed, something which has an especially adverse effect on use in the automotive or aircraft industry.

On the basis of this state of the art the object of the invention is to create a hook-and-loop fastener exclusively of plastic the hook-and-loop fastening elements of which can still assume different geometric configurations even after their production and which is of lightweight structure and cost-effective in production. The object as thus formulated is attained by a hook-and-loop fastener having the characteristics specified in claim 1 in its entirety.

In that, as specified in the descriptive portion of claim 1, at least the hook-and-loop fastening elements consist of a plastic material with shape memory capability such that, when passing through different energy states, and in particular at different temperatures, each of the hook-and-loop fastening elements assumes an interlocking shape and/or orientation different from the interlocking shape and/or orientation determined at the outset, it is possible to modify a hook-and-loop fastener geometrically after it has been produced, by way of an energy charge, so that the fastener may be used for a greater number of applications.

In particular, the production of hook-and-loop fasteners can be appreciably simplified and made cost-effective if a sort of base form of the fastener is produced in a first shaping process and this base form is then modified by use of the shape memory capability of the plastic in such a way that in another second or later shaping step the hook-and-loop fastener is obtained with the configurations and orientations actually desired. By preference, however, the energy states to be introduced into the hook-and-loop fastener material, as well as the glass transition temperatures of the plastic material itself which are selected, are such that in any event at the usual ambient temperatures such as occur in the environment a stable fastening is present and the desired configurations do not change unintentionally.

Other advantageous embodiments of the hook-and-loop fastener claimed for the invention are specified in the dependent claims.

The hook-and-loop fastener claimed for the invention is explained in detail in the special description.

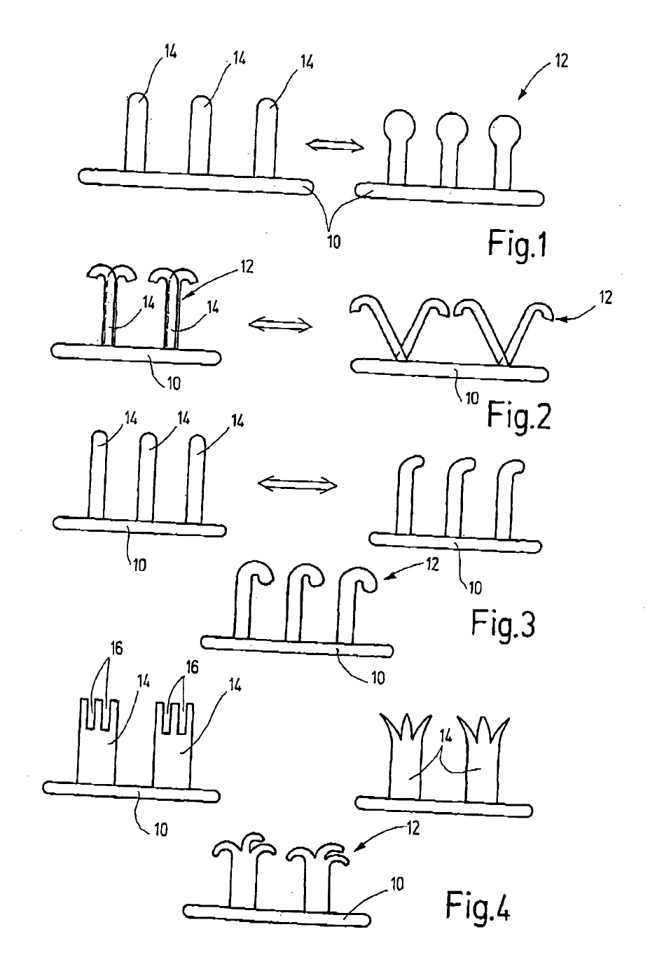

FIGS. 1 to 4 illustrate, by sections, in diagrams not drawn to scale, the varying shaping behavior of the hook-and-loop fastener with shape memory.

The hook-and-loop fastener consists of a strip or sheet backing component 10 which carries on its upper side hook-and-loop fastening elements designated as a whole as 12. With hook-and-loop fastening elements (not shown) with which a so-called back-to-back solution is applied, the possibility also exists of mounting hook-and-loop fastening elements on the two opposite sides of the backing component. The hook-and-loop fastening elements 12 are generally arranged in continuous rows sequentially and juxtaposed, the row of hook-and-loop fastening elements 12 being considered in FIGS. 1 to 4 exclusively with reference to sections on the backing component 10. In addition, the hook-and-loop fastening elements 12 may be designed to be geometrically significantly smaller than those shown in the figures and accordingly are also known and usable as microfasteners.

The conventional hook-and-loop fastening elements 12 are made from a plastic material with shape memory capability so that when they pass through different energy states, particularly at different temperatures, each of the hook-and-loop fastening elements 12 assumes another interlocking shape and/or orientation different from the interlocking shape and/or orientation initially assumed. A specific interlocking shape and/or orientation may be associated with a predetermined energy state or energy range, a temperature state or temperature range in particular. In addition, the geometric changes are kept reversible for the hook-and-loop fastening elements 12.

In order to reach a shape state from another shape state and vice versa by use of the shape memory capability of the plastic material, each shape state is first prestamped mechanically by a conventional plastic molding process.

Polymer materials or composite materials produced from them are especially well suited as plastic material with shape memory capability. The plastic material with shape memory capability preferably is a block copolymer and has at least one block component A with a glass transition temperature between −60° C. and 300° C., in particular between −40° C. and 270° C., preferably between 30° C. and 150° C. The block copolymer also has another block component with a glass transition temperature which is at least 10° C. lower than that of block component A. In addition, the two block components A, B are correspondingly cross-linked to each other.

In the configuration in question it is possible to subject the respective hook-and-loop fastening element 12 to a single shape modification process. An example of this process is shown in FIG. 1. A backing component 10 with simple fastening stems 14 is first produced in a first shaping step by a conventional process. A great number of disclosed production processes are available for this purpose and thus will not be described in greater detail at this point. If the fastening stems 14 still at an elevated temperature as a result of the first shaping process are now cooled and a predetermined amount of energy is removed from them, by preference only at the free end of the fastening stems 14, the latter are reshaped in a second mechanical shaping step to form spherical interlocking shapes for the hook-and-loop fastening elements 12, as are to be seen reproduced on the right in simplified form in the line of sight to FIG. 1. The reshaping process involved takes place as soon as the glass transition temperature for the specific plastic material used has been reached. Should the fastening stems 14 still be more or less amorphous in structure, this structure changes after the specific glass transition temperature has been exceeded and the plastic material is then provided with a shape orientation and/or texture, at least in the area of the spherical interlocking ends. Since no new plastic material is added in the mechanical reshaping process during the energy removal, it goes without saying that the length of the hook-and-loop fastening elements 12 with the spherical interlocking shape is correspondingly reduced in relation to that of the fastening stems 14. The shape shown on the right in FIG. 1 possesses with its plastic material a shape memory capability such that a regrouping process may then take place in both directions and also so as to be reversible between the two mechanical shaping states, that is, in the event of addition of energy or heating the spherical interlocking elements may also be reshaped to assume the form of the fastening stems 14, as is illustrated on the left in FIG. 1. The spherical interlocking elements are stable in shape and can absorb forces at the ambient temperatures customarily prevailing.

Consequently, by preference use is made of plastic materials with shape memory capability such that the fastening stems 14 are mechanically formed at a high shaping temperature, such as 150° C., and such that the spherical interlocking elements shown in FIG. 1 automatically assume their mechanically assigned shape when the material cools to room or ambient temperature. These interlocking elements then retain their assigned shape and orientation after the glass transition temperature has been exceeded and the temperature drops from high to low levels and it would require an energy supply step, a step involving elevation of the temperature above the specific glass transition temperature in particular, to change the shape again to that of the fastening stems 14 illustrated.

Since the hook-and-loop fastening elements 12 of plastic are more or less kept elastic, the possibility exists, for a technical application for example, of connecting to each other two fastening components with spherical interlocking heads to form a hook-and-loop fastening, the spherical interlocking heads of one hook-and-loop fastening element 12 then being detachably engaged in the spaces between two adjacent spherical head interlocking shapes. By simple change in the energy state, the temperature in particular, it is then possible to connect or disengage a hook-and-loop fastener of this configuration by simple means and to ensure dependability of operation, without the need for application by hand of greater actuating forces such as are required in the case of conventional fasteners.

In the embodiment of a hook-and-loop fastener shown in FIG. 2, hook-and-loop fastening elements 12 are produced on the backing component 10 in a double-hook configuration, which in the line of sight to the figure are seen to be made up of pairs of individual hooks in a sequential configuration, in a conventional plasticization production process which is not described in detail here. If the configuration involved passes through a lower energy state in accordance with an additional shaping process, during cooling for example, the individual hook elements of each double hook undergo another previously assigned mechanical orientation and are spread apart. The respective modified orientation of the spread hook-and-loop fastening elements 12 is shown on the right in FIG. 2. The purpose of the double arrows in FIG. 2 in turn is to illustrate that the process may take place in the opposite direction. In cooling to a customary ambient temperature the hook-and-loop fastening elements 12 then retain their spread position because of their shape memory capability and a looped material (not shown) of another hook-and-loop fastener component can extend below the hooks of the spread hook-and-loop fastening elements 12 as is required to produce the hook-and-loop fastening.

In another embodiment of the hook-and-loop fastener claimed for the invention illustrated in FIGS. 3 and 4, there is added to the two block components A and B at least one additional block component C cross-linked to them, the respective glass transition temperature selected for each additional block component being always at least 10° C. lower than that of the respective preceding block component. The initial plastic material for the embodiment illustrated in FIGS. 3 and 4 accordingly has a solid block component A of a block copolymer with a glass transition temperature of 150° C. The block copolymer also has a block component B whose glass transition temperature is at approximately 100° C. and an additional block component C with a glass transition temperature of 50° C., for example, is added. If the fastening stem 14 on the backing component 10 as shown in FIG. 3 is now cooled starting at approximately 150° C., after the first glass transition temperature has been passed mechanical shaping is applied to obtain for the hook-and-loop fastening elements 12 a first hooked shape bent at a right angle, and when the additional glass transition temperature of 50° C. is passed a third mechanical shaping step is taken such that the hook-and-loop fastening elements 12 assume their definitive shaped position with distinctly full curved hooked shape. The respective process involved is also kept reversible and may be carried out by suitable heating of the plastic material in the opposite sequence. The plastic material may then be “switched back and forth” between the mechanically assigned states of the system.

In the embodiment illustrated in FIG. 4 the fastening stems 14 are provided on the end with notches 16 and in a first specified cooling step the fastening stems 14 assume the central configuration shown as a result of shaping, in which configuration the ends of the stem material which delimit the notches 16 are separated to form a group of three. If additional cooling is now carried out and the second glass transition temperature is passed through, for example, one of the order of magnitude of 50° C. as a result of further shaping, the free ends of the stem material are bent and a triple hook or anchor element for the hook-and-loop fastener is obtained. The double-arrow configuration again illustrates the possible reversal of sequence between the mechanically assigned system states.

If there is added to the block components A, B, and C illustrated another block component, D for example, which is at a temperature at least 10° C. below its glass transition temperature than is block component C, another, fourth, potential configuration is obtained. A number of geometric modification options as large as desired may in theory accordingly be produced by further addition of soft block components to the cross-linked block copolymer.

The interlocking shape of the hook-and-loop fastening elements 12 may consist of a looped material (not shown) or of interlocking heads such as hooks (FIG. 3), double hooks (FIG. 2), or multiple hooks (see FIG. 4), anchor elements, fastening stems 14 (see FIG. 1)—including ones provided with notches 16 on the ends (see FIG. 4)—or (spherical) interlocking mushrooms (see FIG. 1), which may reversibly assume a minimum of one additional geometric configuration which is assigned by a mechanical shaping process, in addition to a possible first geometric configuration, as a result of their shape memory capability. Change in the length or orientation may be achieved in particular with the looped material referred to.

It has been found to be especially advantageous to select as polymer material with shape memory capability such material from the group of polyesters, polyamides, polyesteramides, polyurethanes, aliphatic polyurethanes in particular, polysaccharides, polyacrylates, polysiloxanes, and copolymers of such substances. In addition or as an alternative, the plastic material with shape memory capability may also be provided with chitosans, carboxymethyl cellulose, and/or biodegradable plastics as filler.

Provision may also be made for designing one of the block components as a polymer block which is a homopolymer of a vinyl aromatic compound, a copolymer of a vinyl aromatic compound, and of a conjugate diene compound and/or contains a product of hydrogenation of this compound. The respective other block component preferably is a polymer block which contains a homopolymer of the butadiene, a copolymer of the butadiene with another conjugate diene compound, a copolymer of the butadiene with an aromatic vinyl compound, and/or a product of hydrogenation of these polymers.

In order to obtain different energy states for the plastic material with shape memory capability use is made of energy means such as ultrasound, light, in the form of laser light in particular, moisture (H₂O), electric current, magnetic fields, and changes in pressure and mass, which may be employed individually or in combination with each other.

In addition to the geometric modifications indicated, it is also possible to modify cross-sectional shapes of the hook-and-loop fastening elements 12. Thus, for example, cylindrical structures on fastening stems 14 may be restructured to polygons or the like (not shown). It is in any event possible to produce a subsequent plurality of widely varying configurations and/or orientations for the hook-and-loop fastening elements 12 rapidly and cost-effectively from a cost-effectively produced initial material and by use of a plastic material with shape memory capability and by appropriate predetermination of shape, so that the cost of conventional shaping processes involving complex shaping tools costly to produce may be largely reduced or at least simplified.

1. A hook-and-loop fastener consisting of a backing component (10) which is provided on at least one of its sides with hook-and-loop fastening elements (12) of a predetermined interlocking shape and/or orientation, characterized in that the hook-and-loop fastening elements (12) have a plastic material with shape memory capability such that, on passage through different energy states, in particular at different temperatures, each of the hook-and-loop fastening elements (12) assumes an interlocking shape and/or orientation different from the initially predetermined interlocking shape and/or orientation.

2. The hook-and-loop fastener as claimed in claim 1, wherein a specific interlocking shape and/or orientation of the hook-and-loop fastening elements (12) may be associated with a predetermined energy state or energy range, a temperature state or temperature range in particular, and wherein the changes in the geometric configurations are kept reversible for the hook-and-loop fastening elements (12).

3. The hook-and-loop fastener as claimed in claim 1 or 2, wherein the plastic material is a polymer with shape memory capability or a composite material prepared from such polymer.

4. The hook-and-loop fastener as claimed in one of claims 1 to 3, wherein the plastic material with shape memory capability is a block copolymer and has at least one block component A with a glass transition temperature between −60° C. and 300° C., in particular between −40° C. and 270° C., preferably between 30° C. and 150° C., and at least one block component B with a glass transition temperature which is at least 10° C. lower than that of block component A, and wherein the respective block components A, B are cross-linked to each other.

5. The hook-and-loop fastener as claimed in claim 4, wherein there is added to the two block components A and B at least one other block component C cross-linked to them and wherein the respective glass transition temperature selected for each additional block component is at least 10° C. lower than the glass transition temperature of the respective preceding block component.

6. The hook-and-loop fastener as claimed in one of claims 1 to 5, wherein the polymer material with shape memory capability employed is selected from the group made up of polyesters, polyamides, polyurethanes, aliphatic polyurethanes in particular, polysaccharides, polyacrylates, polysiloxanes, and copolymers thereof.

7. The hook-and-loop fastener as claimed in claim 6, wherein, in addition or as an alternative, the plastic material with shape memory capability is provided with chitosans, carboxymethylcellulose, and/or biologically degradable plastic materials.

8. The hook-and-loop fastener as claimed in claim 4, wherein one of the block copolymers is a polymer block which contains a homopolymer of a vinyl aromatic compound, a copolymer of a vinyl aromatic compound, and one other aromatic vinyl compound and a conjugate diene compound and/or a hydration product thereof and wherein the respective other block component is a polymer block which contains a homopolymer of butadiene, a copolymer of butadiene with a vinyl aromatic compound and/or a product of hydrogenation of these polymers.

9. The hook-and-loop fastener as claimed in one of claims 1 to 8, wherein the interlocking shape of the hook-and-loop fastening elements (12) consists of looped material or of interlocking heads such as hooks, double or multiple hooks, anchor elements, fastening stems (14)—ones also provided on the end with notches (16)—or fastening mushrooms, which, in addition to a possible first geometric configuration based on their shape memory capability, reversibly assume at least one other geometric configuration.

10. A process for production of a hook-and-loop fastener as claimed in one claims 1 to 9, characterized in that, in order to reach different energy states for the plastic material with shape memory capability, ultrasound, light, in the form of laser light in particular, moisture (H₂O), electric current, magnetic fields, and changes in temperature, pressure, and mass are employed as energy means, either individually or in combination with each other.

11. The process as claimed in claim 10, wherein each desired shape of hook-and-loop fastening elements (12) is predetermined mechanically and wherein, at least on passage through the glass transition temperature of the plastic material with shape memory capability, a first shape is modified to a second shape so that on change in the energy means or on change in energy the plastic material reversibly assumes both shapes alternately.
